(19) United States
(12) Patent Application Publication
(10) Pub. No.: US 2026/0217982 A1
(43) Pub. Date: Jul. 30, 2026

(54) Synergists for Dimeric Pigments

(71) Applicant: Cabot Corporation, Boston, MA (US)

(72) Inventors: Alexander I. Shakhnovich, Arlington, MA (US); Heather E. Clarke, Nashua, NH (US)

(21) Appl. No.: 19/145,567

(22) PCT Filed: Jan. 9, 2024
(86) PCT No.: PCT/US2024/010839

§ 371 Date: Jul. 3, 2025

Related U.S. Application Data
(60) Provisional application No. 63/479,809, filed on Jan. 13, 2023.

(51) Int. Cl. C09B 67/22; C09B 31/043; C09B 31/147; C09B 67/20

(52) U.S. Cl. CPC C09B 67/0041; C09B 31/043; C09B 31/147; C09B 67/0066

(57) ABSTRACT

Disclosed herein are compositions comprising a dimeric (diarylide) pigment and a synergist, in which the synergist has a structure similar to a monomer of the dimeric pigment. Also disclosed are aqueous dispersions and inkjet inks comprising such compositions. In a first preferred composition, the symmetric diarylide pigment has the following structure: (P-1) and the synergist has the following structure: (S-1). In a second preferred composition, the symmetric diarylide pigment has the following structure: (P-2) and the synergist has the following structure: (S-2).

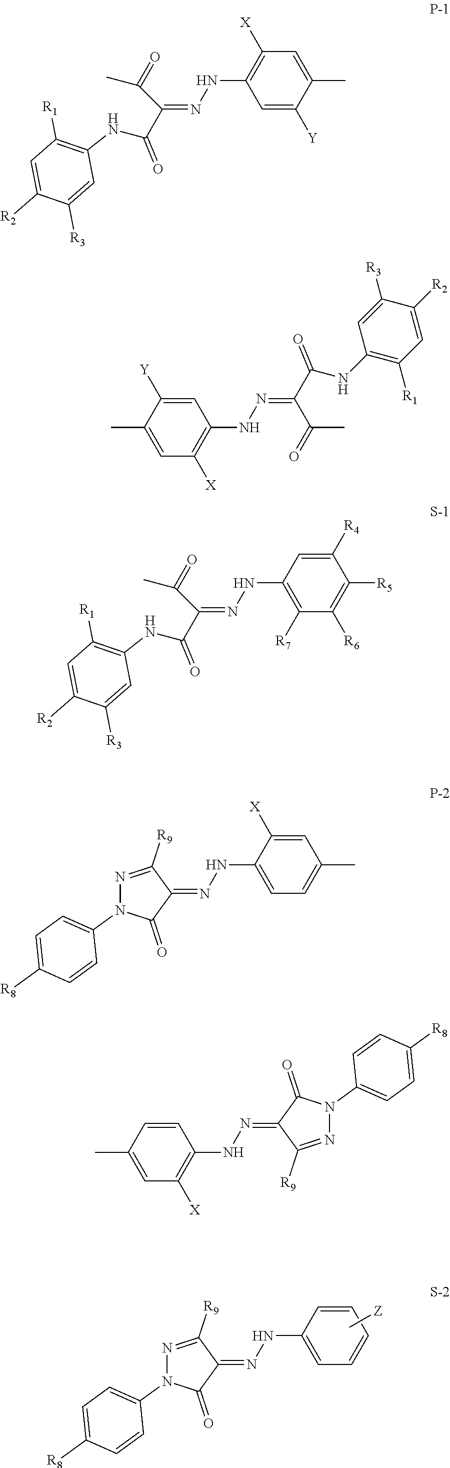

### FIELD OF THE INVENTION

Disclosed herein are synergists for dimeric pigments. Also disclosed are dispersions and inks containing such synergists that can be useful in applications such as inkjet ink applications.

### BACKGROUND

In general, pigments are not readily dispersible in aqueous liquid vehicles, which creates challenges for formulating pigment-based inks. To improve dispersibility, various developments have been undertaken, including the use of dispersing aids or dispersants, which are typically surfactants and water-soluble polymers. Alternatively, the pigment can be modified to include ionic compounds, rendering the pigment self-dispersible. These strategies, however, may not be optimal for certain formulation types. Accordingly, there remains a need to develop methods for dispersing pigments in aqueous vehicles.

### SUMMARY

Disclosed herein is a composition comprising:
a symmetric diarylide pigment comprising a monomer; and
a synergist that is structurally similar to the monomer of the diarylide pigment.

The symmetric diarylide pigment can have the following structure P-1:

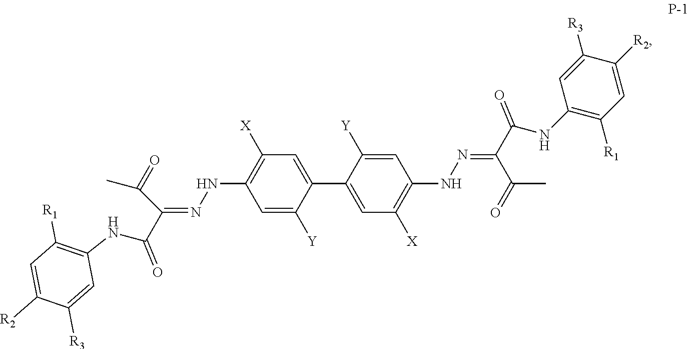

wherein R₁, R₂, and R₃ are independently selected from H, Cl, C₁-C₆ alkyl, and C₁-C₆ alkoxy, X is selected from Cl and C₁-C₆ alkyl, and Y is selected from H and Cl; and
the synergist can have the following structure S-1:

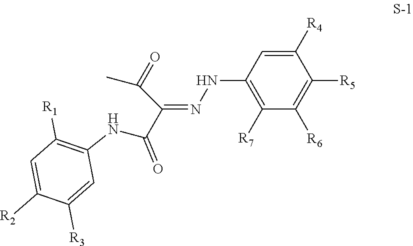

wherein R₄, R₅, R₆, and R₇ are independently selected from H, Cl, C₁-C₆ alkyl, C₁-C₆ alkoxy, -L-OH, -L-COOH, -L-SO₃H, and -L-PO₃H₂, and salts thereof, wherein L is a divalent linker, and at least one of R₄, R₅, R₆, and R₇ is selected from -L-COOH, -L-SO₃H, -L-PO₃H₂, and salts thereof.

The symmetric diarylide pigment can have the following structure P-2:

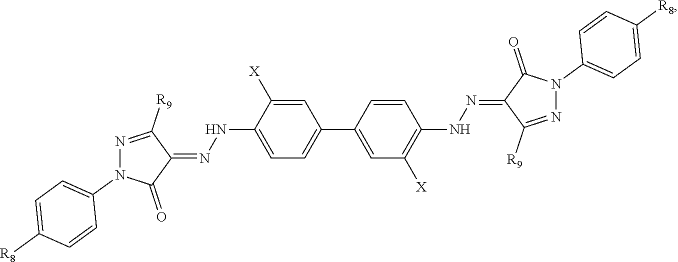

(b) the synergist has the following structure S-2:

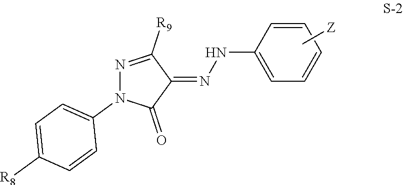

wherein X=Cl, C₁-C₆ alkyl, or C₁-C₆ alkoxy, R₈=H or C₁-C₆ alkyl, R₉=H, C₁-C₆ alkyl, or CO₂CH₂CH₃ and Z is an ionic or ionizable group.

### DETAILED DESCRIPTION

Stabilizing pigments in aqueous dispersions generally requires providing the pigment with a charged surface. Many techniques and materials have been employed, including reacting the pigment with various electrophilic or radical agents bearing charged groups (e.g., diazonium cations, sulfur trioxide, chlorosulfonic acid, 1,3,5-triazinyl radicals), or encapsulating pigment particles in a shell of charged polymer.

Incorporating dispersants having at least one functional group can also impart dispersibility to the pigment in an aqueous pigment dispersion or ink (e.g., inkjet ink) composition through adsorption to the pigment. The functional group can be either ionic (or ionizable) or can create steric hindrance. Synergists are a type of dispersant that can physically adsorb to the pigment due to its structural similarity to the pigment. Synergists often contain an ionic or ionizable functional group to provide the pigment with electrostatic dispersibility in aqueous media. Synergist design may also account for one or more factors including solubility of the synergist in a dispersion or ink formulation in addition to its affinity for the pigment. Moreover, modern inkjet inks have been developed with more complex formulas, which may require factoring multiple ink parameters, such as particle size distribution and ink viscosity, to achieve stability over extended periods of time. For example, inkjet inks may be required to be filterable through a 0.5-2 μm filter, which requires that the pigments substantially maintain their particle size. With these multiple factors, designing synergists for pigments in general can be challenging.

In general, a chromophore is defined as a molecule or part of a molecule that contains a sufficient number of conjugated double bonds to absorb visible light (360-750 nm). For example, an azo chromophore has an electron-withdrawing aryl group connected to an electron-donating group through an azo bond (—N═N—). An electron-donating group in this case may be a substituted aryl group, an acetoacetarylide, or a heterocyclic group. A common approach in the design of pigments involves combining two identical chromophores in a single pigment molecule via connection through a divalent linker that may or may not be electron-insulating. Examples of linkers may include a bond (such as a single C—C bond), an aryl ring system (e.g., a para-substituted phenyl ring, a di-substituted fused aryl ring system having 2 (e.g., naphthalene), 3, 4, or more fused aryl rings, etc.), an alkyl chain having the formula —(CH₂)ₙ—, or an ether chain like —O—(CH₂)ₙ—O— where n=1-6. In one embodiment, the linker is a bond, a para-substituted phenyl ring, a di-substituted naphthalene ring, an alkyl chain having the formula —(CH₂)ₙ—, or an ether chain like —O—(CH₂)ₙ—O— where n=1-6. This approach can effectively double the molecular weight of the pigment, which can increase its solvent and thermal resistance without influencing the coloristic properties.

Typically, these dimeric pigments are symmetric and can be represented as AB₂, where A represents the linker that connects two chromophore residues, B. The chromophore residues, B, can also be referred to as a monomer of the pigment. Examples of such dimeric pigments include diarylide pigments. Diarylide pigments can be prepared by tetrazotization of benzidine or substituted benzidine. In a more specific example, the linker A in Pigment Yellow 12 is a single bond between aryl residues of a tetrazotized benzidine or a benzidine derivative. Linker A is a single bond and monomer B is as shown in the structure of Pigment Yellow 12 below:

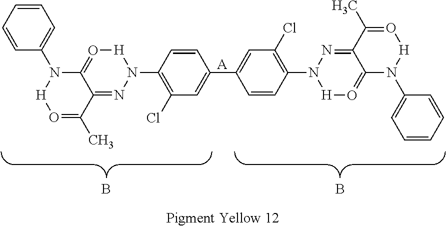

To prepare the dimeric pigment, a tetrazotized compound (e.g., benzidine or benzidine derivative) can be coupled with two identical nucleophilic couplers, which can be substituted acetoacetanilides (yellow pigments), pyrazolones (orange pigments) or substituted naphtholes (red pigments). Specific examples include Pigment Yellow 12 (the coupler is acetoacetanilide), Pigment Orange 13 (the coupler is phenylmethylpyrazolone), and Pigment Orange 34 (the coupler is tolyl methyl pyrazolone). These examples are illustrated in the Schemes A and B below, in which a linker A is a single bond and the monomer B contains the respective couplers and a 2′-chloroaniline unit resulting from (tetrazotized 3,3′-dichlorobenzidine).

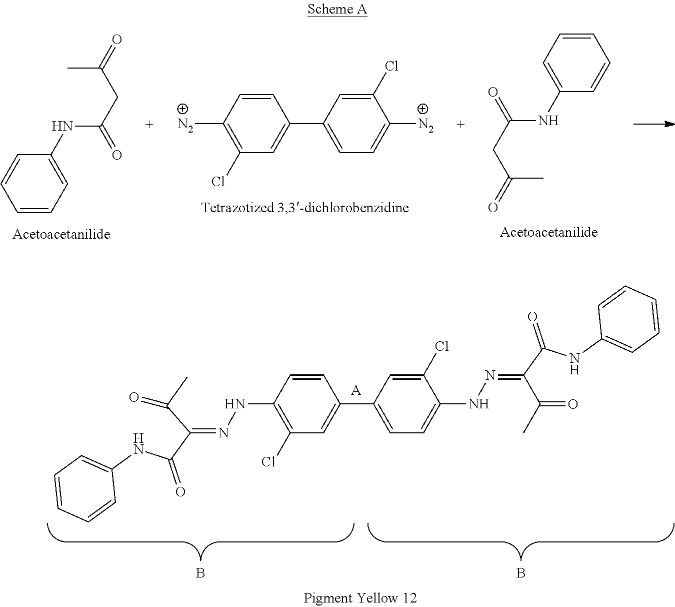

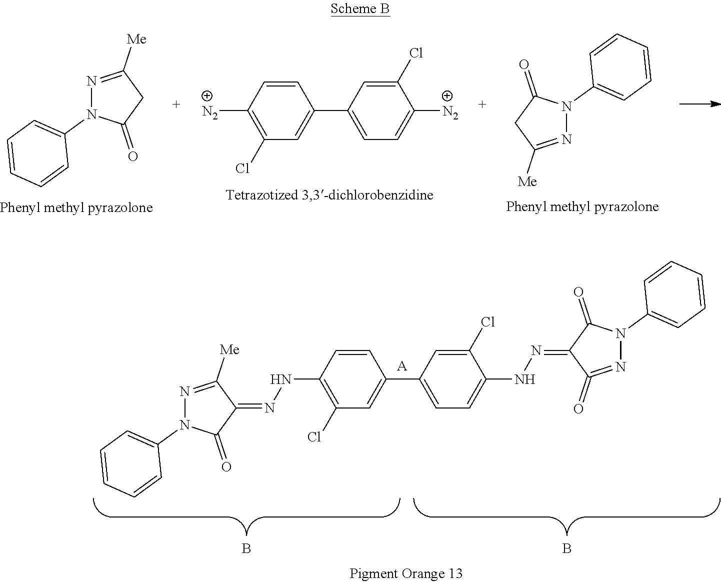

A synergist could be designed for a dimeric pigment such that the synergist would be structurally similar to that of the parent dimer, i.e., the synergist also has a dimeric structure (“full synergist”). Full synergist examples are depicted below:

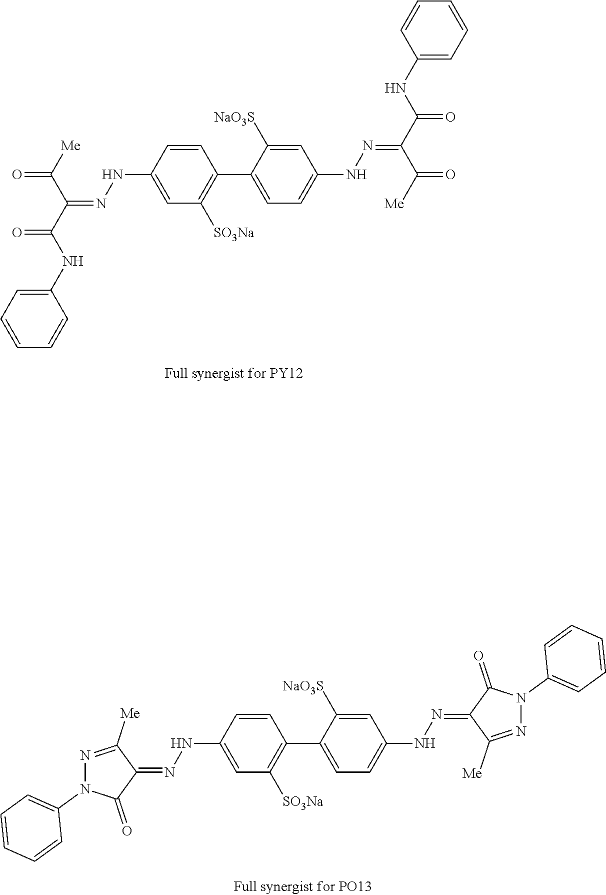

These molecules, unfortunately, can have high water solubility due to the presence of two or more ionizable groups, such as the two SO₃Na groups depicted above. The high solubility in water could decrease the affinity of the full synergist to the parent pigment. Other symmetric synergists with similar structure and different configuration of charged groups can be prepared, but the starting materials may not be as readily available.

It has been discovered that good performance can be achieved with synergists that are structurally similar to a monomer of the dimeric pigment (“half synergist”). A half synergist for Pigment Yellow 12 is depicted below:

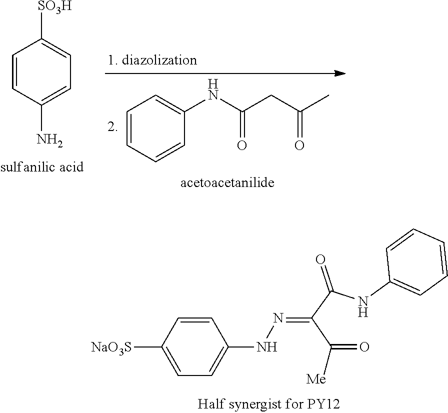

Accordingly, disclosed herein are dispersions or compositions comprising a pigment and a synergist, wherein the pigment has a dimeric structure (a dimeric pigment such as a diarylide pigment). The synergist would be structurally similar to a monomer of the dimeric structure, e.g., a derivative of the monomer. By structural similarity or structurally similar, it is meant that the synergist contains an identical structural section and a distinct structural section to a monomer of the dimeric pigment. In one embodiment, the identical structural section comprises at least 50% of the total molecular weight of monomer of the dimeric or diarylide pigment, e.g., at least 60%, at least 70%, at least 80% or at least 90% of the total molecular weight of monomer of the pigment but no more than 99% or no more than 95% of the total molecular weight of the monomer of the pigment. In one embodiment, the synergist is a derivative of a monomer of the pigment. Because the synergist is structurally similar to a monomer of the dimeric pigment, as an option the molecular weight of the synergist is no greater than 70% the molecular weight of the dimeric or diarylide pigment, e.g., no greater than 60% the molecular weight of the dimeric pigment, e.g., the molecular weight of the synergist ranges from 25-70%, from 30-70%, from 35-70%, from 40-75%, from 45-70%, from 50-70%, from 55-70%, or from 60-70% the molecular weight of the dimeric pigment. Thus, the synergist is a material separate from the pigment that is capable of providing a stable dispersion of the pigment in a liquid vehicle.

Without wishing to be bound by any theory, the structural similarity between a monomer of the pigment and synergist results in the synergist potentially having a high affinity for the pigment. A high affinity in turn can aid in the adsorption of the synergist to the pigment surface. In one embodiment, this high affinity can take the form of Van der Waals interactions (e.g., dipole-dipole interactions). In one embodiment, the synergist further comprises an ionic or ionizable group that allows additional interactions between the pigment and synergist, including one or more of n-n stacking, ionic interactions/bonding, hydrogen bonding, and acid/base interactions/reactions. In one embodiment, both the pigment and synergist have an ionic or ionizable group, thereby providing interactions as described herein (e.g., Van der Waals interactions, n-n stacking, ionic interactions/bonding, acid/base interactions/bonding, and hydrogen bonding). Moreover, adsorption of a synergist molecule on a face of pigment crystals can creates a dislocation, which potentially prevents further crystal growth along this face, thereby providing a handle to control and/or maintain the size and distribution of pigment particles.

Without wishing to be bound by any theory, if the pigment contains two identical chromophores connected by a single bond, the symmetry would result in net zero electronic interaction. The chromophores can be considered as essentially independent. Any absorption characteristics of a monomeric and corresponding dimeric colorant molecule would likely be similar in terms of hue angle and strength such that the added synergist would typically not ‘dilute’ the color of the pigment. As a result, the color of monomeric synergist would likely be similar to the color of dimeric pigment. Moreover, a half synergist would provide a lesser number of ionizable groups less water-soluble than a full synergist. Less competition from water interactions can consequently result in stronger affinity to a pigment surface.

Finally, as synergists are additives, the use of synergists can simplify the ink formulation process by avoiding a purification step, which may be required in other dispersion techniques, such as with dispersant additives.

Accordingly, disclosed herein are compositions comprising a dimeric pigment and a synergist that is structurally similar to a monomer of the dimeric pigment. The dimeric pigment can be a diarylide, acetoacetanilides (yellow pigments), aryl pyrazolones (orange pigments), substituted naphtholes (red pigments), perylene pigments, such as Pigment Red 149, Pigment Red 178, and disazocondensation pigments such as Pigment Yellow 93, Pigment Red 144, and Pigment Red 214. The aryl groups of the diarylide can be joined by a linker, which can be the single bond linking aryl groups of a benzidine or substituted benzidine residue (e.g., dichlorobenzidine residue such as 3,3′-dichlorobenzidine residue).

In one embodiment, the symmetric diarylide pigment has the following structure P-1:

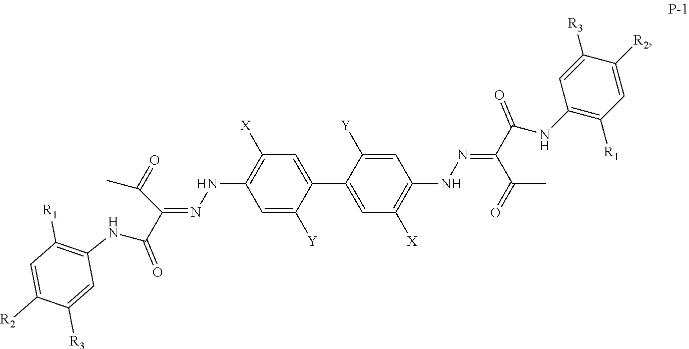

wherein R₁, R₂, and R₃ are independently selected from H, Cl, C₁-C₆ alkyl (e.g., methyl or ethyl), and C₁-C₆ alkoxy (e.g., methoxy or alkoxy), X is selected from Cl and C₁-C₆ alkyl (e.g., methyl or ethyl), and Y is selected from H and Cl. For example, R₁ and R₂ are independently selected from H, Cl, C₁-C₆ alkyl (e.g., methyl or ethyl), and C₁-C₆ alkoxy (e.g., methoxy or alkoxy) and R₃ is selected from H, Cl, and C₁-C₆ alkyl (e.g., methyl or ethyl). In another example, R₁, and R₂, are independently selected from H, Cl, methyl, and methoxy, R₃ is selected from H and methoxy (e.g., R₃ is H), X is selected from Cl and methyl, and Y is selected from H and Cl. In yet another example, R₁ is selected from H, methyl, and methoxy (e.g., R₁ is selected from H and methyl), R₂ is selected from H and methyl, and R₃ is H. Exemplary pigments include yellow pigments such as Pigment Yellow 12, Pigment Yellow 13, Pigment Yellow 14, Pigment Yellow 16, Pigment Yellow 17, Pigment Yellow 81, and Pigment Yellow 83. The diarylide pigment can be the majority or minority pigment in the composition. For example, some commercial grades of Pigment Yellow 126 can contain small amounts of Pigment Yellow 12, and some commercial grades of Pigment Yellow 127 can contain small amounts of Pigment Yellow 13.

The compositions containing at least one pigment having the structure P-1 can have at least one synergist having the following structure S-1:

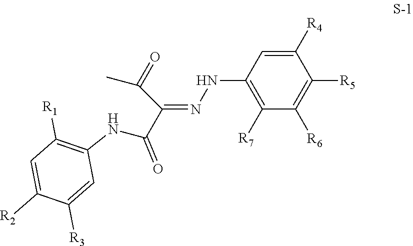

wherein R₁-R₃ are as defined for pigment P-1, and R₄, R₅, R₆, and R₇ are independently selected from H, Cl, C₁-C₆ alkyl (e.g., methyl or ethyl), and C₁-C₆ alkoxy (e.g., methoxy or alkoxy), -L-OH, -L-COOH, -L-SO₃H, -L-PO₃H₂, and salts thereof, wherein L is a divalent linker (such as a (single) bond, an aryl ring system, an ether chain like —O—(CH₂)ₙ—O—, or an alkyl chain having the formula —CHₙ— where n=1-6), and at least one of R₄, R₅, R₆, and R₇ is selected from -L-COOH, -L-SO₃H, -L-PO₃H₂, and salts thereof, e.g., at least one of R₄, R₅, R₆, and R₇ is selected from —COOH, —SO₃H, and —PO₃H₂, and salts thereof. By “salts thereof” is meant that the acid group may be in a partially or fully ionized form having a cationic counterion, e.g., M⁺, such as Na⁺, K⁺, Li⁺, or NR′₄⁺, wherein R′, which can be the same or different, represents hydrogen or an organic group such as a substituted or unsubstituted aryl (e.g., phenyl) and/or alkyl group (e.g., C₁-C₆ alkyl). It is also understood that the R₁, R₂, and R₃ substitutions of the synergist can be independent from the substitutions on the pigment, e.g., the same or different from that of the pigment.

In another embodiment, the symmetric diarylide pigment has the following structure P-2:

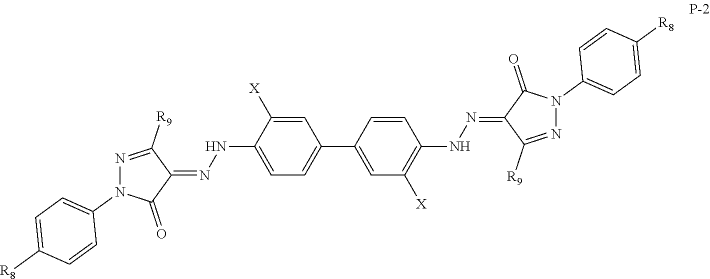

and the synergist has the following structure:

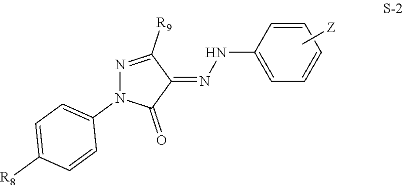

wherein X=Cl, C₁-C₆ alkyl, or C₁-C₆ alkoxy, R₉=H or C₁-C₆ alkyl, R₉=H, C₁-C₆ alkyl, or CO₂CH₂CH₃, and Z is an ionic or ionizable group. Accordingly, disclosed herein are compositions (e.g., aqueous dispersions, ink or inkjet compositions) comprising the dimeric pigment and synergist. Examples of such pigments include Pigment Orange 13 and Pigment Orange 34.

In one embodiment, X=Cl, C₁-C₂ alkyl, or C₁-C₂ alkoxy, e.g., X=Cl or C₁-C₂ alkoxy (e.g., OCH₃). In one embodiment, R₉=H or C₁-C₂ alkyl, e.g., R₂=H or CH₃. In one embodiment, R₉=H, C₁-C₂ alkyl, or CO₂CH₂CH₃, e.g., R₉=H, CH₃, or CO₂CH₂CH₃, or R₉=H or CH₃. The structure above has an azo group and Z can be positioned ortho, meta or para to the azo group in the structure, e.g., Z can be positioned meta or para to the azo group in the structure. It is understood that the R₈ and R₉ substitutions of the synergist can be independent from the substitutions on the pigment, e.g., the same or different from that of the pigment.

The synergist can have one or more functional groups different from those of the pigment. In one embodiment, the synergist described herein has one functional group that is ionic or ionizable. In one embodiment, the ionic group of the synergist provides hydrophilic properties that renders the synergist soluble or dispersible in a liquid vehicle, e.g., an aqueous solution or water. When the synergist is adsorbed on the pigment, this adsorption can occur preferentially due to its similar structure to the monomer. The synergist in effect can provide charged groups to the pigment surface to also render the pigment dispersible in a liquid vehicle (e.g., an aqueous solution).

In one embodiment, the synergist contains an ionic or ionizable group. An ionizable group is one that is capable of forming an ionic group in the medium of use. Anionic groups are negatively charged ionic groups that can be generated from groups having ionizable substituents that can form anions (anionizable groups), such as acidic substituents. Cationic groups are positively charged organic ionic groups that can be generated from ionizable substituents that can form cations (cationizable groups), such as protonated amines. By “ionic or ionizable group” it is understood that mixtures can be present in a composition. For example, in a composition, some of the synergists can have an ionic group (i.e., Z is an ionic group) and other synergists can have an ionizable group (i.e., Z is an ionizable group). The distribution of ionic and ionizable groups in a composition can selected by means known in the art, e.g., controlling pH, counterion, etc.

Specific examples of ionic (e.g., anionic) groups include —COO—, —SO₃, —OSO₃⁻, —HPO₃⁻; —OPO₃²⁻, or —PO₃²⁻ (having a cationic counterion, e.g., M, as defined herein), and specific examples of an ionizable (e.g., anionizable) groups can include —COOH, —SO₃H, —PO₃H₂, —R′SH, or —R′OH, where R′ represents H or an organic group, such as a substituted or unsubstituted aryl or alkyl group. Also, specific examples of cationic or cationizable groups include alkyl or aryl amines, which can be protonated in acidic media to form ammonium groups —NR′₂H⁺, where R′ represent an organic group, such as a substituted or unsubstituted aryl or alkyl groups, e.g., substituted or unsubstituted C₅-C₂₀ aryl or C₁-C₁₂ alkyl (e.g., C₁-C₆ alkyl) group. Organic ionic groups include those described in U.S. Pat. No. 5,698,016, the disclosure of which is incorporated herein by reference.

In certain embodiments, the ionic group is, e.g., —COO—, —SO₃—OSO₃, —HPO₃⁻, —OPO₃²⁻, or —PO₃²⁻, such as —COO⁻, —SO₃⁻, or —PO₃²⁻. In other embodiments, the ionizable group is, e.g., —COOH, —SO₃H, —PO₃H₂, —R′SH, or —R′OH, such as —COOH, —SO₃H, or —PO₃H₂. in other embodiments, the ionic or ionizable group is —SO₃⁻ or —SO₃H. In other embodiment, the composition comprises at least a portion of synergists having an ionic group and at least another portion of synergists having an ionizable group.

Without wishing to be bound by any theory, it is believed that due to the relatively low molecular weight of the synergist, providing more than one ionic and/or ionizable group may result in a synergist that is too hydrophilic, potentially rendering the synergist soluble in water and enabling its desorption from the pigment surface into the continuous phase.

Another embodiment provides a composition (e.g., a dispersion or ink, such as inkjet ink) comprising the dimeric pigment and the at least one synergist described herein. In one embodiment, the at least one synergist is present in the composition in an amount ranging from 3% to 10% by weight relative to the weight of the dimeric pigment. For example, the at least one synergist is present in the composition in an amount ranging from 3% to 9%, from 3% to 8%, from 4% to 10%, from 4% to 9%, from 4% to 8%, from 5% to 10%, from 5% to 9%, or from 5% to 8%, by weight relative to the weight of the dimeric pigment.

In one embodiment, the at least one synergist in the composition is a mixture of more than one synergist having the structure described herein, e.g., a mixture of synergists in which each synergist has one or more substituents that are different from each other.

In one embodiment, the at least one synergist according to the claimed invention can be prepared via a diazonium reaction. For example, a diazonium reagent can be prepared from an aminobenzene reactant having an ionic or ionizable group in the ortho, meta, or para position (e.g., meta or para) to the amine group combined with a base (e.g., NaOH) and sodium nitrite (see first step of Scheme C below, illustrating with a synergist of structure S-2). The aminobenzene reactant can be, e.g., sulfanilic acid or aminobenzoic acid. The resulting diazonium reagent can then be combined with the coupler (e.g., acetoacetanilides, phenylpyrazolone, naphtholes, etc.) to form the at least one synergist.

For example, the phenyl group of the phenylpyrazolone can be substituted with an R₈ group (e.g., ortho, meta, or para to the pyrazolonyl, or meta or para to the pyrazolonyl), and the pyrazolonyl can contain an R₉ group, as shown in Scheme C below, in which R₈ and R₉ are defined as above.

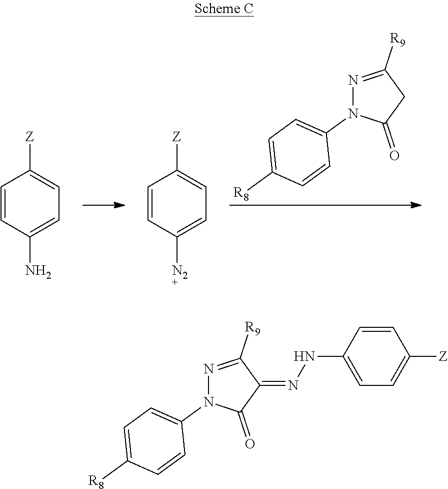

Accordingly, disclosed herein is a method of preparing the at least one synergist comprising combining an aminobenzene reactant, substituted with an ionic or ionizable group in the aryl ring, with a base to form a diazonium reagent. The method further comprises combining the diazonium reagent with a coupler (e.g., acetoacetanilides, phenylpyrazolone, naphtholes, etc.) to form the at least one synergist. In the case of a synergist having the structure S-2, the phenyl group of the phenylpyrazolone has an R₈ substituent and the pyrazolonyl has an R₉ substituent, wherein R₈=H or C₁-C₆ alkyl, R₉=H, C₁-C₆ alkyl, or CO₂CH₂CH₃, and Z is an ionic or ionizable group.

Pigments are solid materials generally in the form of a particulate solid. The particulate solid can be a powder, a dispersion, or a pressed cake. Such particle sizes can be achieved by one or more conventional size reduction, comminution, and/or classification techniques, such as ball milling, media milling, jet milling, sonication, fluid impingement, and centrifugation to remove undesired large particles. Median particle size can be determined by dynamic light scattering techniques with equipment produced by companies such as Microtrac, Inc., and Malvern Panalytical, Ltd., as examples. In one embodiment, the pigment has a median particle size ranging from 100 nm to 300 nm, e.g., from 100 nm to 250 nm, from 100 nm to 225 nm, from 100 nm to 200 nm, from 100 nm to 180 nm, from 120 nm to 250 nm, from 120 nm to 225 nm, from 120 nm to 200 nm, from 120 nm to 180 nm, from 150 nm to 250 nm, from 150 nm to 225 nm, from 150 nm to 200 nm, or from 150 nm to 180 nm. The particle size can be a mean diameter based on volume (mean volume, Mv) or number distribution. Dispersions comprising the pigment can be purified by ultrafiltration, diafiltration, ion exchange, centrifugation, or a combination of one or more such methods.

It has been discovered that the claimed synergist enhances the stability of the pigment in a dispersion or an ink. Stability can be gauged by, e.g., median particle size of the pigment in a dispersion or an ink. In one embodiment, the median particle size of the pigment dispersion or ink containing the claimed synergist does not significantly increase in size over a certain time period, e.g., at least 7 days, or at least two weeks, or at least 6 weeks, either at room temperature or at 60° C., 70° C., or 80° C. In one embodiment, the median particle size does not increase by more 30% relative to its initial median particle size. For example, the median particle size does not increase by more than 25%, does not increase by more than 20%, does not increase by more than 15%, does not increase by more than 10%, or does not increase by more than 10% relative to its initial median particle size.

Alternatively or in addition, stability can be gauged by viscosity of the pigment dispersion or ink. In one embodiment, the viscosity (cP) of the pigment dispersion or ink does not significantly increase over a certain time period, e.g., at least 7 days, or at least two weeks, or at least 6 weeks, either at room temperature or at 60° C. In one embodiment, the viscosity does not increase by more than 30% relative to its initial viscosity. For example, the viscosity does not increase by more than 25%, does not increase by more than 20%, does not increase by more than 15%, does not increase by more than 10%, or does not increase by more than 10% relative to its initial viscosity. When the median particle size or viscosity increases by more than 30% relative to its initial median particle size or viscosity (or other percentages as described herein), typically this occurs as a result of agglomeration, which can cause the pigment to undesirably settle and/or gel.

In addition, or in an alternative embodiment, an ink or dispersion comprising the dimeric pigment and the synergist is stable over a certain time period, e.g., at least 7 days, or at least two weeks, or at least 6 weeks, either at room temperature or at 60° C. For example, stability can be gauged by the capability of the ink or dispersion to maintain certain physical properties, in which physical properties can include particle size, pH, surface tension, viscosity, and can be maintained within 10% of its original values.

In one embodiment, the composition comprises a liquid vehicle. In one embodiment, the liquid vehicle is aqueous. For example, an aqueous vehicle can be an aqueous solution, e.g., comprises at least 40% water, e.g., at least 45% water or at least 50% water. In one embodiment, the composition is a pigment dispersion, e.g., an aqueous pigment dispersion. In another embodiment, the composition is an ink (e.g., inkjet ink) composition, e.g., an aqueous ink (e.g., inkjet ink) composition.

In one embodiment, the composition is an aqueous pigment dispersion comprising the dimeric pigment in an amount ranging from 1% to 40% by weight relative to the total weight of the pigment dispersion, e.g., from 1% to 30%, from 1% to 20%, from 1% to 10%, from 3% to 40%, from 3% to 30%, from 3% to 20%, from 3% to 10%, from 5% to 40%, from 5% to 30%, from 5% to 20%, or from 5% to 10% by weight relative to the total weight of the pigment dispersion.

In one embodiment, the composition is an aqueous ink (e.g., inkjet ink) composition. In one embodiment, the composition comprises the dimeric pigment in an amount ranging from 1% to 15% by weight, e.g., from 1% to 10% by weight, relative to the total weight of the composition, e.g., an amount ranging from 2% to 15%, from 2% to 10% by weight, from 3% to 15%, from 3% to 10% by, from 1% to 7%, from 2% to 7%, or from 3% to 7% by weight, relative to the total weight of the composition.

In one embodiment, the composition, e.g., aqueous pigment dispersion or aqueous ink (e.g., inkjet ink) composition further comprises at least one organic solvent present in an amount ranging from 1% to 50% relative to the total weight of the inkjet ink composition (e.g., the aqueous vehicle is an aqueous solution). For example, the aqueous pigment dispersion or aqueous ink can comprise at least two organic solvents (co-solvents). The at least one organic solvent can be present in the composition in addition to at least 40% water (or at least 45% water or at least 50% water). In one embodiment, the organic solvent is soluble or miscible in water. In another embodiment, the organic solvent is chemically stable to aqueous hydrolysis conditions (e.g., reaction with water under heat aging conditions, including, for example, the hydrolysis of esters and lactones). In one embodiment, the organic solvent has a dielectric constant below that of water, such as a dielectric constant ranging from about 10 to about 78 at 20° C. Examples of suitable organic solvents include alcohols and polyols (glycols, glycerols, etc.), amides, ketones or ketoalcohols, ethers, ureas or urea derivatives, hydroxyamide derivatives, saccharides, sulfoxide derivatives, and sulfone derivatives. The at least one organic solvent can comprise mixtures of organic solvents.

Humectants and water-soluble organic compounds other than the at least one organic solvent may also be added to the inkjet ink composition of the present invention, e.g., for the purpose of preventing clogging of the nozzle as well as for providing paper penetration (penetrants), improved drying (drying accelerators), and anti-cockling properties. In one embodiment, the humectant and/or water-soluble compound is present in an amount ranging from 0.1% to 50%, e.g., an amount ranging from 1% to 50%, from 0.1% to 30%, from 1% to 30%, from 0.1% to 10%, or from 1% to 10%.

In one embodiment, an ink composition (e.g., an inkjet ink composition) comprises at least one surfactant, e.g., when the pigment is not self-dispersible. The at least one surfactant can enhance the colloidal stability of the composition or change the interaction of the ink with either the printing substrate, such as printing paper, or with the ink printhead. Various anionic, cationic and nonionic dispersing agents can be used in conjunction with the ink composition of the present invention, and these may be used neat or as a water solution. In one embodiment, the surfactant is present in an amount ranging from 0.05% to 5%, e.g., an amount ranging from 0.1% to 5%, or from 0.5% to 2%, by weight relative to the total weight of the inkjet ink composition.

In one embodiment, the ink (e.g., inkjet ink) composition has a viscosity ranging from 1-25 cP. It is understood that viscosity can be adjusted by a variety of methods. In one embodiment, polymeric binders can be used in conjunction with the inkjet ink composition disclosed herein to adjust the viscosity of the composition and/or provide other desirable properties, such as durability (e.g., at least one durability polymer). Such polymeric binders can be present in the composition in an amount ranging from 0.1% to 20% by weight relative to the total weight of the composition, e.g., an amount ranging from 0.1% to 10%, from 0.1% to 5%, from 0.2% to 20%, from 0.2% to 10%, from 0.2% to 5%, from 0.5% to 20%, from 0.5% to 10%, or from 0.5% to 5% by weight relative to the total weight of the composition.

In one embodiment, the ink (e.g., inkjet ink) composition can further comprise one or more suitable additives to impart a number of desired properties while maintaining the stability of the compositions. Other additives are well known in the art and include humectants, biocides and fungicides, pH control agents, drying accelerators, penetrants, and the like. The amount of a particular additive will vary depending on a variety of factors but are generally present in an amount ranging between 0.01% and 40% based on the weight of the ink composition. In one embodiment, the at least one additive is present in an amount ranging from 0.05% to 5%, e.g., an amount ranging from 0.1% to 5%, or an amount ranging from 0.5% to 2%, by weight relative to the total weight of the inkjet ink composition.

### EXAMPLES

Reaction products were identified by HPLC-MS (Agilent 1100 connected to a Thermo LTQ XL with Electrospray ionization; column: Zorbax Extend C18, 4.6×150 mm, Sum), from Agilent Technologies, Inc. Particle sizes (Mv) were measured by using a Nanotrac™ 252 particle size analyzer produced by Microtrac, Inc.

### Example 1: Preparation of Synergist S-1

This Example describes the preparation of synergists having the structure S-1. The synthesis is outlined in Scheme D below.

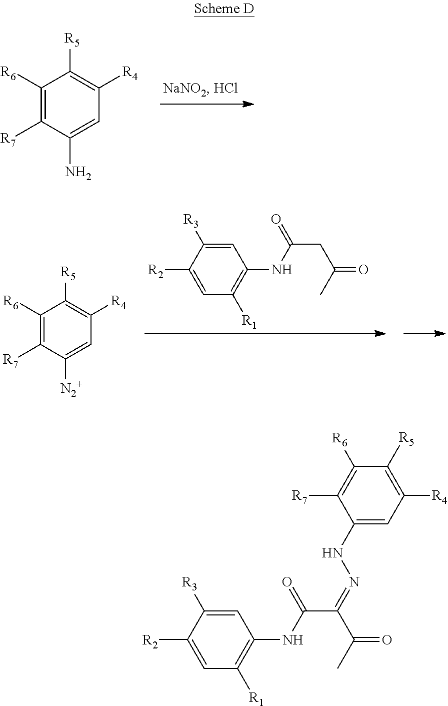

To prepare the diazonium solution, sulfanilic acid (17.7 g) was dissolved in a mixture of 100 mL deionized water and 40% sodium hydroxide solution (10.2 g), followed by the addition of sodium nitrite (7.0 g). The resulting solution was added dropwise to a stirred mixture of 36% hydrochloric acid (18.9 mL) and ice-water (150 g). Excess nitrous acid was neutralized by the addition of 25% solution of sulfamic acid (2-4 g).

The coupler solution was prepared by dissolving acetoacetanilide (AAA, 18.3 g) in a mixture of 40% sodium hydroxide solution (10.4 g), isopropanol (200 mL) and DI water (200 mL). Azo coupling was conducted by adding diazonium salt solution to the stirred coupler at pH 4-6; the pH was maintained by adding of 1 M sodium hydroxide as needed. The precipitated dye was filtered off and washed with a small amount of ice water. The yield was 85%; HPLC purity was 96% by area. Other yellow synergists were prepared the same way (with acetoacet-2′,4′-xylidide (AAX) or acetoacet-2′-toluidide (AAOT) in place of AAA), as indicated in Table 1, along with corresponding yields and purity. For all synergists, R₄ and R₇ are each H.

TABLE 1

| | | | | | | | Abbreviated | |
|---|---|---|---|---|---|---|---|---|
| R₁ | R₂ | R₃ | R₅ | R₆ | Yield % | Purity % | Name* | Pigment |
| H | H | H | SO₃H | H | 85 | 96 | SA-AAA | PY12 |
| H | H | H | H | SO₃H | 86 | 92 | MA-AAA | PY12 |
| Me | Me | H | SO₃H | H | 80 | 95 | SA-AAX | PY13 |
| Me | Me | H | H | SO₃H | 79 | 96 | MA-AAX | PY13 |
| Me | H | H | SO₃H | H | 82 | 97 | SA-AAOT | PY14 |
| Me | H | H | H | SO₃H | 83 | 94 | MA-AAOT | PY14 |

*Abbreviations: SA—sulfanilic acid, MA—metanilic acid, AAA—acetoacetanilide, AAOT—acetoacet-2′-toluidide, AAX—acetoacet-2′,4′-xylidide.

### Example 2: Preparation of Synergist S-2

This Example describes the preparation of a synergist for Pigment Orange 34 according to the claimed invention in which the synergist has a structure S-2. The synthesis of Synergist S-2 is outlined in Scheme E below. In Scheme E, either Z₁ or Z₂ is an ionic or ionizable group.

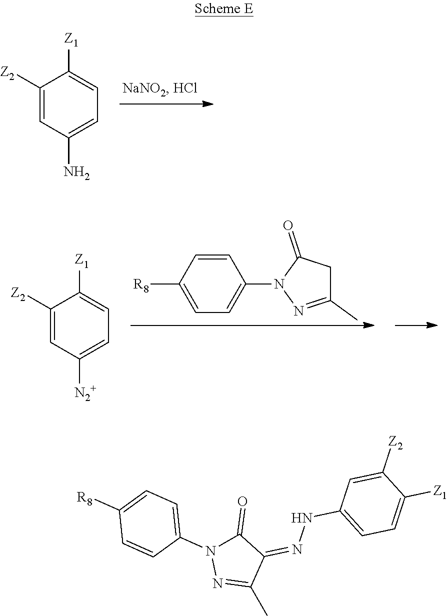

The synergists were prepared in a manner similar to Example 1 except diazotized SA or MA are coupled with either PMP or TMP. Results are shown in Table 2.

TABLE 2

| | | | | | Abbreviated | |
|---|---|---|---|---|---|---|
| R₈ | Z₁ | Z₂ | Yield % | Purity % | Name* | Pigment |
| H | SO₃H | H | 84 | 95 | SA-PMP | PO13 |
| H | H | SO₃H | 80 | 95 | MA-PMP | PO13 |
| Me | SO₃H | H | 82 | 96 | SA-TMP | PO34 |
| Me | H | SO₃H | 80 | 94 | MA-TMP | PO34 |

*Abbreviations: SA—sulfanilic acid, MA—metanilic acid, PMP—phenyl methyl pyrazolone, TMP—tolyl methyl pyrazolone

### Comparative Examples: Preparation of Full Synergists

This Example describes the preparation of full synergists for both the yellow and orange pigments, as outlined in Schemes F and G, respectively.

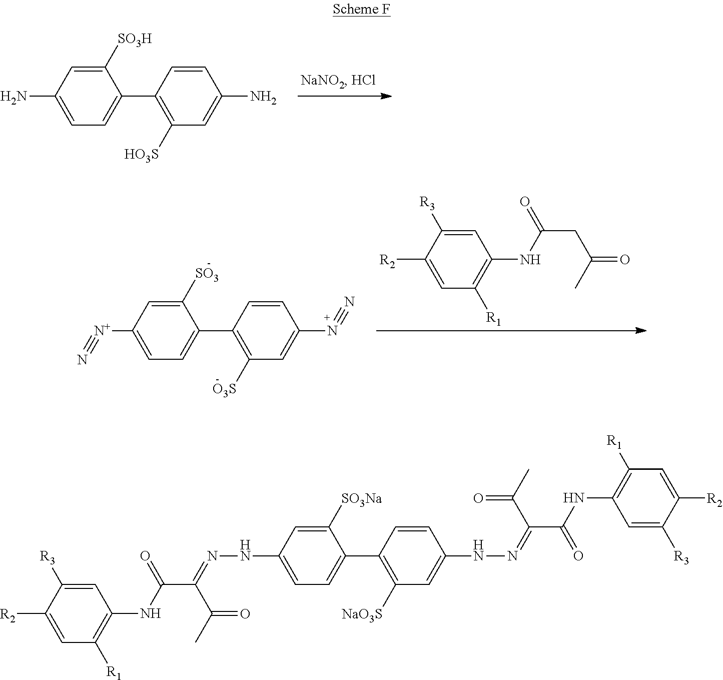

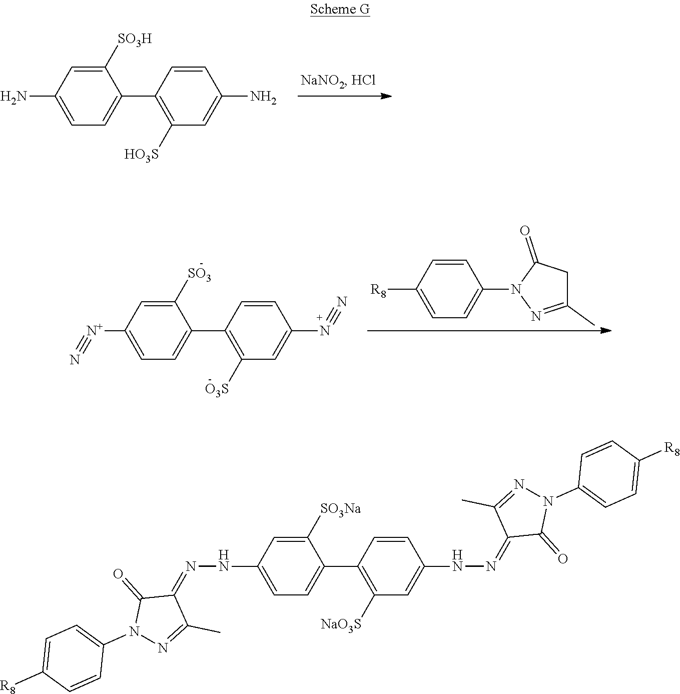

To prepare the full yellow synergist, a diazonium solution of benzidine-2,2′-disulfonic acid (“BDSA”) (TCI Chemical; 26.2 g of 82% solution) was dissolved in a mixture of 150 ml deionized water and 40% sodium hydroxide solution (12.8 g), followed by the addition of sodium nitrite (8.6 g) was added. The resulting solution was added dropwise to the stirred mixture of 36% hydrochloric acid (23.6 mL) and ice-water (250 g). Excess nitrous acid was neutralized by addition of 25% solution sulfamic acid (2-4 g).

The coupler solution was prepared by dissolving acetoacetanilide (AAA, 23.1 g) in a mixture of 40% sodium hydroxide solution (13.0 g), isopropanol (200 mL) and 200 mL of DI water. Azo coupling was conducted by adding diazonium salt solution to the stirred coupler at pH 4-6; pH was maintained by adding of 1 M sodium hydroxide as needed. The precipitated dye was filtered off and washed with small amount of ice water. The yield is was 70%; HPLC purity was 96% by area.

The other full synergists were prepared in a similar manner with acetoacet-2′,4′-xylidide (AAX) or acetoacet-2′-toluidide (AAOT) in place of AAA. The water solubility of full synergists, based on BDSA was much higher than that of the corresponding half synergists of Example 1. Sometimes the dye precipitated as a reddish yellow oil (saturated solution in isopropanol-water), but eventually it crystallized. Other full synergists are prepared the same way and their yields and purity are given in Table 3.

TABLE 3

| | | | | | Abbreviated | |
|---|---|---|---|---|---|---|
| R₁ | R₂ | R₃ | Yield % | Purity % | Name* | Pigment |
| H | H | H | 70 | 96 | BDSA-AAA | PY12 |
| Me | Me | H | 68 | 95 | BDSA-AAX | PY13 |
| Me | H | H | 73 | 97 | BDSA-AAOT | PY14 |

*Abbreviations: BDSA—benzidine-2,2′-disulfonic acid, AAA—acetoacetanilide, AAX—acetoacet-2′,4′-xylidide, AAOT—acetoacet-2′-toluidide

The full synergists for orange pigments (Scheme G) were prepared the same way except tetrasotized BDSA was coupled with either PMP or TMP (Table 4).

TABLE 4

| | | | Abbreviated | |
|---|---|---|---|---|
| R₈ | Yield % | Purity % | Name* | Pigment |
| H | 73 | 95 | BDSA-PMP | PO13 |
| Me | 75 | 96 | BDSA-TMP | PO34 |

*Abbreviations: BDSA—benzidine-2,2′-disulfonic acid, PMP—phenyl methyl pyrazolone, TMP—tolyl methyl pyrazolone

### Pigment Dispersions

In general, charge stabilized particles in water have 175-350 μmol of counterion per 1 g of pigment to provide adequate sedimentation resistance. In this Example, the synergists contained 4.8-6.1% of sodium counterion. To achieve ~175 μmol/g counterion content, the dispersions contained from 6% to 7.5% of synergist by weight of pigment.

Pigment Yellow 12 (55 g Sun Chemical, Sunbrite Yellow 12) was mixed in a heavy wall flask with MA-AAA synergist (3.51 g) and deionized water (312 mL). Vacuum was applied to wet the pigment and the resulting pre-dispersion was homogenized in a rotor-stator mixer at 5,000 rpm for 1 h, and then sonicated for 3 h using Misonix sonicator with horn at 180-200 W power. The dispersion was centrifuged at 2,500 g for 15 min. to remove undispersed material and decanted from centrifuge sludge. The mean volume particle size (Mv) was then measured.

Other dispersions were prepared in a similar manner. The properties of the dispersions are shown in Table 5 below:

TABLE 5

| | | Synergist | | |
|---|---|---|---|---|
| | | Type | | Mv |
| Pigment | Synergist | (Full/Half) | Solids | (nm) |
| PY12 | MA-AAA | Half | 11.48% | 216.4 |
| PY12 | SA-AAA | Half | 12.14% | 212.5 |
| PY14 | MA-AAOT | Full | 11.96% | 214 |
| PY14 | SA-AAOT | Half | 11.71% | 218.9 |
| PY13 | MA-AAX | Half | 14.05% | 196.5 |
| PY13 | SA-AAX | Full | 12.04% | 198.3 |
| PO13 | MA-PMP | Half | 13.32% | 181.7 |
| PO13 | SA-PMP | Half | 12.13% | 190.9 |
| PO34 | MA-TMP | Full | 11.76% | 163.3 |
| PO34 | SA-TMP | Half | 13.67% | 179.7 |
| PY12 | BDSA-AAA | Half | 10.70% | 207.9 |
| PY13 | BDSA-AAX | Full | 12.65% | 209.1 |
| PY14 | BDSA-AAOT | Half | 11.76% | 222.2 |
| PO13 | BDSA-PMP | Half | 11.61% | 177.4 |
| PO34 | BDSA-TMP | Full | 11.43% | 152.8 |

The effect of synergists was evaluated by heat aging the dispersions at 60° C. for 4 weeks. A change of ±10% for Mv of the dispersion was defined as acceptable. The results are summarized in Table 6:

TABLE 6

| | | Synergist Type | Mv |
|---|---|---|---|
| Pigment | Synergist | (Full/Half) | growth, % |
| PY12 | MA-AAA | Half | 0.4% |
| PY12 | SA-AAA | Half | −0.8% |
| PY12 | BDSA-AAA | Full | 556.6% |
| PY13 | MA-AAX | Half | 4.3% |
| PY13 | SA-AAX | Half | 5.8% |
| PY13 | BDSA-AAX | Full | 66.4% |
| PY14 | MA-AAOT | Half | 3.7% |
| PY14 | SA-AAOT | Half | 8.2% |
| PY14 | BDSA-AAOT | Full | 309.1% |
| PO13 | MA-PMP | Half | 4.3% |
| PO13 | SA-PMP | Half | −6.3% |
| PO13 | BDSA-PMP | Full | 68.0% |
| PO34 | MA-TMP | Half | 2.9% |
| PO34 | SA-TMP | Half | 2.7% |
| PO34 | BDSA-TMP | Full | 1000% |

From the data of Table 6, it can be seen that the dispersions containing the half synergists demonstrated good (minimal) Mv growth, whereas all comparative dispersions containing full synergists exceeded, and thus failed, minimal Mv growth requirements.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A composition comprising:
a symmetric diarylide pigment comprising a monomer; and
a synergist that is structurally similar to the monomer of the diarylide pigment.

2. The composition of claim 1, wherein the synergist contains an identical structural section and a distinct structural section to the monomer of the diarylide pigment wherein the identical structural section comprises at least 50% of the total molecular weight of the monomer.

3. The composition of claim 1, wherein the synergist has a molecular weight of no more than 70% the molecular weight of the pigment.

4. The composition of claim 1, wherein the monomer comprises (a) a residue comprising an acetoacetanilide, a pyrazolone, or a naphthole, and (b) a residue comprising benzidine.

5. The composition of claim 1, wherein:
the symmetric diarylide pigment has the following structure P-1: 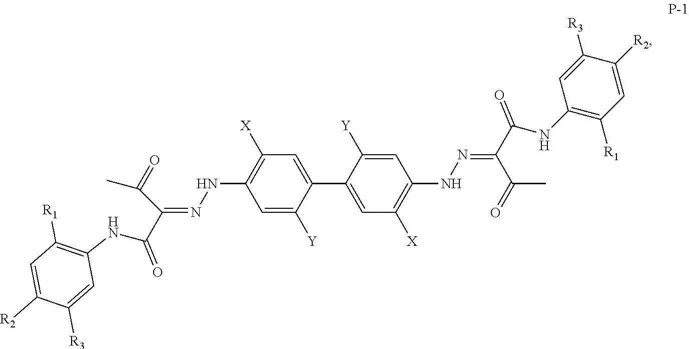
wherein R₁, R₂, and R₃ are independently selected from H, Cl, C₁-C₆ alkyl, and C₁-C₆ alkoxy, X is selected from Cl and C₁-C₆ alkyl, and Y is selected from H and Cl; and
the synergist has the following structure S-1: 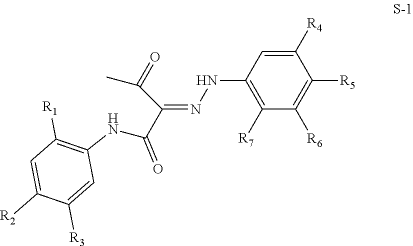
wherein R₄, R₅, R₆, and R₇ are independently selected from H, Cl, C₁-C₆ alkyl, C₁-C₆ alkoxy, -L-OH, -L-COOH, -L-SO₃H, and -L-PO₃H₂, and salts thereof, wherein L is a divalent linker, and at least one of R₄, R₅, R₆, and R₇ is selected from -L-COOH, -L-SO₃H, -L-PO₃H₂.

6. The composition of claim 5, wherein the divalent linker is selected from a bond, an aryl ring system, an alkyl chain having the formula —(CH₂)ₙ—, or an ether chain having the formula —O—(CH₂)ₙ—O—, where n=1-6.

7. The composition of claim 5, wherein R₁ and R₂ are independently selected from H, Cl, C₁-C₆ alkyl, and C₁-C₆ alkoxy and R₃ is selected from H, Cl, and C₁-C₆ alkyl.

8. The composition of claim 5, wherein R₁ is selected from H, methyl, and methoxy, R₂ is selected from H and methyl, and R₃ is H.

9. The composition of claim 5, wherein at least one of R₄, R₅, R₆, and R₇ is selected from —COOH, —SO₃H, and —PO₃H₂, and salts thereof.

10. The composition of claim 1, wherein the pigment is selected from Pigment Yellow 12, Pigment Yellow 13, Pigment Yellow 14, Pigment Yellow 16, Pigment Yellow 17, Pigment Yellow 81, and Pigment Yellow 83.

11. The composition of claim 1, wherein:
the symmetric diarylide pigment has the following structure P-2: 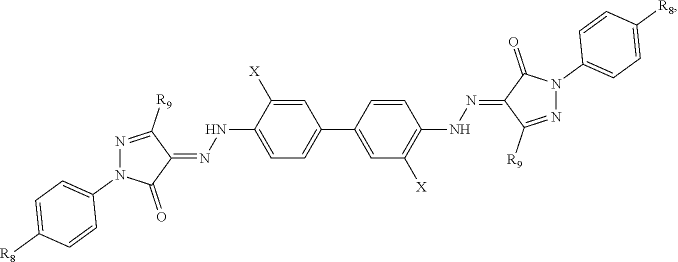
and
(b) the synergist has the following structure S-2: 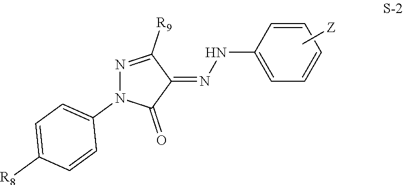
wherein X=Cl, C₁-C₆ alkyl, or C₁-C₆ alkoxy, R₉=H or C₁-C₆ alkyl, R₉=H, C₁-C₆ alkyl, or CO₂CH₂CH₃ and Z is an ionic or ionizable group.

12. The composition of claim 11, wherein X=Cl, C₁-C₂ alkyl, or C₁-C₂ alkoxy.

13. The composition of claim 11, wherein X=Cl or OCH₃.

14. The composition of claim 11, wherein X=Cl.

15. The composition of claim 11, wherein R₉=H, C₁-C₂ alkyl, or CO₂CH₂CH₃.

16. The composition of claim 11, wherein R₉=H, CH₃, or CO₂CH₂CH₃.

17. The composition of claim 11, wherein R₈=H or C₁-C₂ alkyl.

18. The composition of claim 11, wherein R₈=H or CH₃, and R₉=H or CH₃.

19. The composition of claim 11, wherein Z is positioned meta or para to the azo group in the structure.

20. The composition of claim 11, wherein Z is an ionic group.

21. The composition of claim 11, wherein the ionic group is an anionic group.

22. The composition of claim 11, wherein the ionic group is —COO⁻, —SO₃⁻, —OSO₃⁻—, —HPO₃⁻; —OPO₃²⁻, or —PO₃²⁻.

23. The composition of claim 11, wherein the ionic group is —COO—, —SO₃⁻, or —PO₃²⁻.

24. The composition of claim 11, wherein the ionizable group is an anionizable group.

25. The composition of claim 11, wherein the ionizable group is —COOH, —SO₃H, —PO₃H₂, —R′SH, or —R′OH, and R′ is H or a substituted or unsubstituted C₅-C₂₀ aryl or C₁-C₁₂ alkyl group.

26. The composition of claim 11, wherein the ionizable group is —COOH, —SO₃H, or —PO₃H₂.

27. The composition of claim 1, wherein the synergist is present in the composition in an amount ranging from 3% to 10% by weight relative to the weight of the pigment.

28. The composition of claim 1, wherein the pigment has a median particle size ranging from 100 nm to 300 nm.

29.-34. (canceled)
